(19) United States
(12) Patent Application Publication
(10) Pub. No.: US 2025/0153284 A1
(43) Pub. Date: May 15, 2025

(54) VESSEL WELDING, REPAIR, AND RECONDITIONING METHOD AND SYSTEM

(71) Applicants: Daniel IVEY, Central, LA (US); William LEE, Covington, LA (US); John CAPPIELLO, Baton Rouge, LA (US)

(72) Inventors: Daniel IVEY, Central, LA (US); William LEE, Covington, LA (US); John CAPPIELLO, Baton Rouge, LA (US)

(21) Appl. No.: 18/722,129

(22) PCT Filed: Dec. 20, 2022
(86) PCT No.: PCT/US2022/053502

§ 371 Date: Jun. 20, 2024

(51) Int. Cl. B23P 6/00; B23C 3/02; B23K 9/00; B23K 101/12

(52) U.S. Cl. CPC B23P 6/00; B23C 3/02; B23K 9/0026; B23K 2101/12

(57) ABSTRACT

This is a method and device for removing metal or depositing metal from the base metal of a vessel or performing crack and/or defect removal via excavation or other machine work in situ on cylindrical or other surfaces. In a one embodiment, the method and device is used for removing bonded alloy from carbon steel substrate in-situ. In one embodiment, the inventive system and method is used inside a coker unit to remove existing cladding along the weld seams and to prepare the machined area for application of new weld metal. In one embodiment, the method and device is used to deposit weld metal on a surface or in a groove. In one or more embodiments, the groove weld is then inspected for defects and repaired by the device, if required. In one or more embodiments, mapping is performed to autonomously direct the device.

### CROSS-REFERENCE TO RELATED APPLICATIONS

This application claims priority to and the benefit of U.S. Provisional Application No. 63/291,797 filed on Dec. 20, 2021 and entitled “Vessel Reconditioning Method and System.”

### STATEMENT REGARDING FEDERALLY SPONSORED RESEARCH OR DEVELOPMENT

Not Applicable.

### BACKGROUND OF THE INVENTION

### Field of the Invention

This invention relates to the field of welding, industrial maintenance and repair and maintenance of industrial pressure vessels and similar devices.

### Background Information

As used herein, the following terms are defined as shown below:
1. “VESSEL” shall mean, collectively, without limitation, a drum, pressure vessel, vat, tank, digestor or similar device as well as piping and cylinders used in industrial or chemical applications such as oil refining and chemical production.
2. “COKER” shall mean a vessel or drum structure used in the production of carbon black, or “coke”, and which structure is an exemplary embodiment of the inventive device, method and process.
3. “QUENCH” shall mean the rapid cooling of a VESSEL or vessel by use of a cooling agent.
4. “SUBSTRATE” shall mean the base material (typically a form of carbon steel) which forms the walls, exterior or pressure retaining boundary of a VESSEL.
5. “SCANNER” shall mean any device used to collect surface data and transmitting said surface data to a processor for use in mapping the objective surface.
6. “MAPPING” shall mean the process in which a SCANNER collects data detailing the surface of a VESSEL, object, feature, or part and transmits the data to a processor which interprets the data and creates a surface profile data model of the VESSEL interior. The processor then provides the surface profile data model information to either a second processer or directly to the inventive device so that instructions provided based on the surface profile data model can be carried out by the various machining and/or welding tools (e.g., cutting head). The instructions are with reference to the location of surface features that may require modification, for instance, removal of cladding or defects or the addition of weld metal.
7. “CLADDING” shall mean the weld metal (typically a form of alloy) which is deposited along the interior walls and seams of a VESSEL in order to protect the weld seams from erosion/corrosion.
8. “CONSOLE” shall mean the device through which an operator can monitor the operation and functions of the inventive device and take corrective measures, if required.
9. “CONTROL SYSTEM” shall mean collectively, all of the electronic sensors, drives, and control components (including the INSTRUMENTATION SUITE) which gather, receive and analyze data concerning the operation of the inventive device, transmit information to the CONSOLE, receive instructions from the CONSOLE and relay the information to the device.
10. “INSTRUMENTATION SUITE” shall mean, collectively, the bundle of video, audio, thermal, vibration and other sensors used to assess and monitor the operation of the inventive device.

Various industries, such as oil refining and chemical production, employ large diameter VESSEL structures, which are regularly in need of service and/or repair. COKER processing is one example of industry use of such a VESSEL. In this specific application, the product vessels are normally designed as cylinders 80-100 feet in height and 28-30 feet in diameter. The interior of the COKER is covered in CLADDING to reduce erosion/corrosion.

COKERS are operated under high temperatures for long periods of time and are then quickly cooled by QUENCHING. The product, which collects on the interior of the VESSEL, is released from the bottom of the cylinder and the cycle repeats. Expansion and contraction of the steel VESSEL takes place during the heating and QUENCHING cycles thereby inducing stress and wear on the weld joints of the VESSEL.

Any such vessel, including COKERS, if regularly maintained, have relatively long service lives. However, because these types of VESSELS are repeatedly subjected to extreme temperatures, high pressures, and quick cooling, the steel plates, which are welded together to form the vessel walls, are prone to suffer thermal and mechanical fatigue, deformation, and wear.

Reconditioning any VESSEL, including COKERS, is expensive both in terms of cost and in process downtime, especially when manual processes are required. Accordingly, the service life of a VESSEL is an important factor to the end user, from both a productivity and economic standpoint.

The removal of roll bonded or explosion bonded cladding in these VESSELS has traditionally been performed manually by arc gouging (a process of removing metal by means of heat generated from a carbon arc) in the prior art. Arc gouging is currently the, primary, if not sole, method employed commercially. After arc gouging, the surface is smoothed by manual grinding prior to repair of affected areas and application of new weld metal overlay. However, arc gauging requires heating a large region of the vessel wall from the outside prior to commencing the process. The addition of the heat load on the interior of the vessel combined with hexavalent chromium infused smoke (which is a byproduct of arc gouging stainless steel), creates an extremely hazardous environment for workers in the confined space of the vessel.

One typical example of this process is performed on the inside of a COKER vessel. The current practice for the alloy removal inside a COKER vessel requires pre-heat of the entire vessel followed by manual arc gouging and manual grinding. This gouging and grinding work must be performed on or adjacent to the horizontal seams of the vessel (upwards of 80-100 feet high) and around the entire circumference of the VESSEL interior. Manual gouging and grinding of these surfaces is not only costly and time consuming, but it has a high safety risk because of the heights at which the work must be performed. Moreover, this current process does not provide an ideal smooth surface for inspection or repair of the weld seams and can often lead to an uneven surface. This hinders an inspector's ability to identify minor weld flaws as well as a welder's ability to apply the weld metal repair.

This inventive method and system addresses these issues in-situ for not only COKER vessels and other type of industrial VESSELS, but any large metal structure or vessel that requires welding maintenance and repair. While other prior art may allow for use of a cutting device, none provide a similar device for use inside the open environment of a vessel. The inventive system and method provide for use of a computer driven technology to map and follow the uneven surface of a vessel and remove a determined amount of material from the base metal within the vessel. The method is performed using the inventive system described herein.

Further, the inventive method and system can be used for other machining and welding applications besides reconditioning. For instance, new installations via groove welding of the component parts can be performed using the same system with the attachment of various welding components to the inventive system. Further, once the weld is applied, the system can be used with or without the novel MAPPING function to identify repairs needed in the newly applied weld and carry out those repairs. Accordingly, the inventive method and system is highly adaptable for any type of machine work on the exterior, interior, along the seams, along the skirt, etc. of a VESSEL. These improvements allow for VESSELS to work as designed, increases the efficiency of the installation, maintenance, or repair, and enhances the operation of the VESSEL.

### SUMMARY OF THE INVENTION

This is a method and device for removing metal from the base metal of a vessel in situ. It is also a method and device for performing other machine work, such as installation of new welds or repair of base metal or weld defects.

In one embodiment, the method and device is intended for removing bonded alloy from carbon steel substrate in-situ. In one embodiment, the inventive system and method is used inside a COKER unit to remove existing CLADDING along the weld seams and to prepare the machined area for application of new weld metal cladding.

The invention further comprises a device or system that performs the above functions and can be used for a wholistic repair application, including crack excavation, crack removal, milling, and welding.

Prior art practices comprise pre-heating for use of arc gouging and grinding for alloy removal. These processes do not result in an even surface for the desired repair. The current invention delivers a much smoother initial surface finish which eliminates the need for manual grinding and is more efficient for seam inspection (vertical weld joints/and circumferential weld seams), preheating, arc gouging, grinding, and repair. The improved surface finish also makes weld repairs more uniform and is intended to decrease operational issues. These improvements allow for VESSELS to work as designed, increases the efficiency of the repair, and enhances the operation of the VESSEL.

In one or more embodiments, the method is performed using a processor that receives information from a SCANNER about the surface of the vessel and provides instructions to the device directing the path of the device and then determining the amount of metal to remove, the parameters of a weld, or other machine or repair work specifications performed by the device. This system of using a SCANNER to determine the surface profile of the vessel wall and having the surface data interpreted by the processor in order to create a surface profile data model to direct the device is described herein as “MAPPING.”

In one or more embodiments, the MAPPING is performed by an optical or other SCANNER as known in the art located on the inventive device. In other embodiments, the SCANNER may be a separate unit and may be located remotely. In one or more embodiments, the SCANNING device scans the interior of the vessel and sends the information to a processor which then creates profile of the objective surface. The processor then instructs the cutting head of the inventive device as to the amount of CLADDING which is to be removed from the SUBSTRATE at any particular location. The SCANNER may be employed after the decladding device has performed its work to ensure that the proper amount of CLADDING has been removed from the SUBSTRATE. In other embodiments, the processor instructs either a second process to guide other machining, welding, and/or repairs tools on the device to perform welding, excavating, milling, and other machining at a specified location in or on the VESSEL.

The inventive method and system comprise a mounted device attached to a VESSEL in such a manner as to facilitate removal of cladding using a rotating cutting head, welding, excavating, and other machining operations. The device first scans the surface to be machined, for example, decladded, to generate a surface profile data model that is used to control the motion of the proper machining tool, for example, the cutter head. The inventive device is monitored and controlled by an operator through use of the console, either inside or outside the VESSEL. The operation may also be controlled and monitored offsite.

The inventive method allows for consistent removal of material on an uneven surface, such as the inside of a vessel. The inventive device can be attached to the VESSEL using several methods including, but not limited to: nuts or studs welded to the interior of the VESSEL walls or using heavy duty magnets with sufficient holding power to attach the structure of the decladding device. The multi-axis motion envelope of the inventive device allows for proper cutter tool orientation on uneven, curved or flat surfaces.

Using the surface profile data model generated by the MAPPING system, the inventive device positions and guides the cutting head or other machining tool along a preprogramed path and instructs, for example, the cutting head to remove a predetermined amount of material.

In one or more embodiments, the inventive device incorporates a structural frame optimized to minimize mechanical vibration and maximize rigidity for optimal cutting and machining performance and to overcome problems encountered in the prior art. In other embodiments, the device may be attached directly to the work piece without the use of a structural frame.

### BRIEF DESCRIPTION OF THE DRAWINGS

The drawings constitute a part of this specification and include exemplary embodiments of the Vessel Welding, Repair, and Reconditioning Method and System, which may be embodied in various forms. It is to be understood that in some instances, various aspects of the invention may be shown exaggerated or enlarged to facilitate an understanding of the invention. Therefore, the drawings may not be to scale.

FIG. 1 shows an embodiment of the system in a VESSEL.

FIG. 2A shows a side view of one embodiment of the device.

FIG. 2B shows a front view of the embodiment of the device in FIG. 2A.

FIG. 2C shows another embodiment of the device.

### DETAILED DESCRIPTION OF THE INVENTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

In one or more embodiments, the invention is a method for reconditioning a VESSEL comprising: removably coupling a decladding device to the interior wall of a VESSEL, wherein said decladding device comprises a SCANNER, CONTROL SYSTEM and a cutting head; and actuating the SCANNER of the decladding device to provide surface characteristic information of the interior wall of said VESSEL to the CONTROL SYSTEM which generates surface profile data model of the interior wall of the VESSEL and instructs the decladding device to remove metal from the SUBSTRATE of the interior wall of said VESSEL based on the surface profile data model. In one or more embodiments, the method further comprises a decladding device support structure wherein said decladding device support structure comprises two parallel frame arms and one perpendicular frame arm, wherein said perpendicular frame arm supports said cutting head.

Other embodiments of the invention comprise a method for removing metal from a base SUBSTRATE in situ comprising attaching the inventive computer controlled and operated decladding device to an interior wall surface and actuating a SCANNER and CONTROL SYSTEM to create a surface profile data model of the interior surface, wherein the CONTROL SYSTEM determines the amount of metal alloy to be removed from the base substrate and directs the cutting head of the decladding device.

Other embodiments of the invention comprise system for decladding a vessel comprising: a decladding device comprising a cutting head and a frame; a CONTROL SYSTEM in communication with said decladding device; and an umbilical connected to the decladding device; wherein said CONTROL SYSTEM directs the amount of material removed by said decladding device based on the surface profile data map of the vessel as generated by a SCANNER and a MAPPING system. In one or more embodiments, said CONTROL SYSTEM directs said decladding device based on the surface profile characteristic data received from said SCANNER on the decladding device.

In one or more embodiments said CONTROL SYSTEM transmits information regarding the operation and control of the decladding device to a CONSOLE which is monitored by a technician who can make adjustments to the device as needed during operation.

In one or more embodiments, the system further comprises a crack excavation and/or crack removal tool selected from the group consisting of: rotary files, endmills, and stones. In one or more embodiments, the system performs machining of an existing weld overlay along with tapers as required to outside perimeters to eliminate stress risers. Said machining may result in a 10 to 1 profile, 3 to 1 profile, or any other desired profile.

In one or more embodiments, the tool is used as an orbital welding device (vs. a decladding device) while still maintaining the same or similar structure. The device navigates the circular axis of a VESSEL and provides automated MAPPING information as described above of any surface contours or grooves which may require welding. This MAPPING data is then used to automatically direct the path of the welding head. In other embodiments, the information may be manually supplied by a user.

In this embodiment, the tool comprises a welding head capable of producing a groove weld and an excavation tool that can be used to produce excavations as required or to perform additional work such as smoothing or removal of excess weld reinforcement.

In this embodiment, the method is for welding work that comprises removably coupling a welding device to the interior or exterior wall of said VESSEL comprising a welding head and an excavation tool; applying a groove weld using said welding head on an identified area of said VESSEL; after applying said groove weld, identifying repair work needed to said identified area; and performing said repair work on said identified area of said VESSEL, said repair work comprising excavating said identified area of said VESSEL using said excavation tool; wherein said welding device is operated based on a circular axis.

In one or more embodiments, the device comprises a three-point suspension system that is connected to said vessel at four points without imposing a torsional strain on said decladding device frame.

In one or more embodiments, the device uses a modular design. The modular design may be configured so that said decladding device may be reduced to several smaller modules that are capable of being transported through tight spaces such as access manways.

In one or more embodiments, the device further comprises interchangeable components configured to re-apply weld overlay, wherein said interchangeable components use coordinate geometry from the MAPPING systems.

In one or more embodiments, the invention disclosed herein is directed to an efficient removal of existing metal from the base metal of a vessel. In one embodiment, cladding is removed from a vessel base material substrate. In one exemplary embodiment, the VESSEL is a steel industrial VESSEL; however, it would be readily apparent to one skilled in the art that the method of metal removal from a substrate may be applied to a vast number of applications.

In one embodiment, the inventive method and system exposes the base material with a machined surface for better inspection and provides a finish suitable for re-applying CLADDING after repairs.

In one or more embodiments, the cutter head pivots to maintain the spindle perpendicular to the curved surface across the whole area. A SCANNING process uses a touch probe to generate a topographical map for the automatic control of cutter depth (Z axis) during the machining process. Computer controlled adjustable depth of cut, feed rates and cutter rpm allow for optimization of the cutting process. The spindle system has an industry standard tool connection allowing for the use of a wide range of off the shelf tooling (cutters).

In one or more embodiments, the invention comprises a custom made and unique tool connection system as well as a head, which will allow the use of industry standard tool connection points within the device and system. This allows for use of a wide range of tools, as needed, for specific applications. Overall, the process significantly reduces the time, resources, effort, and cost of current removal practices while improving the final finish quality and increasing safety by allowing the operator the opportunity to control the device while remaining outside of the VESSEL.

In one embodiment, the system is modular. In one embodiment, the system can be broken down into basic elements designed to fit though an 18-inch diameter manhole and easily assembled inside the vessel. In one embodiment, in operation a 7 foot by 3-foot rectangular area (21 sq. ft.) can be machined automatically before repositioning the machine for another cycle of cutting. In other embodiments the reach of the machine before repositioning is a 4 foot by 12-foot rectangular area. In other embodiments still, the operational area may be larger or smaller.

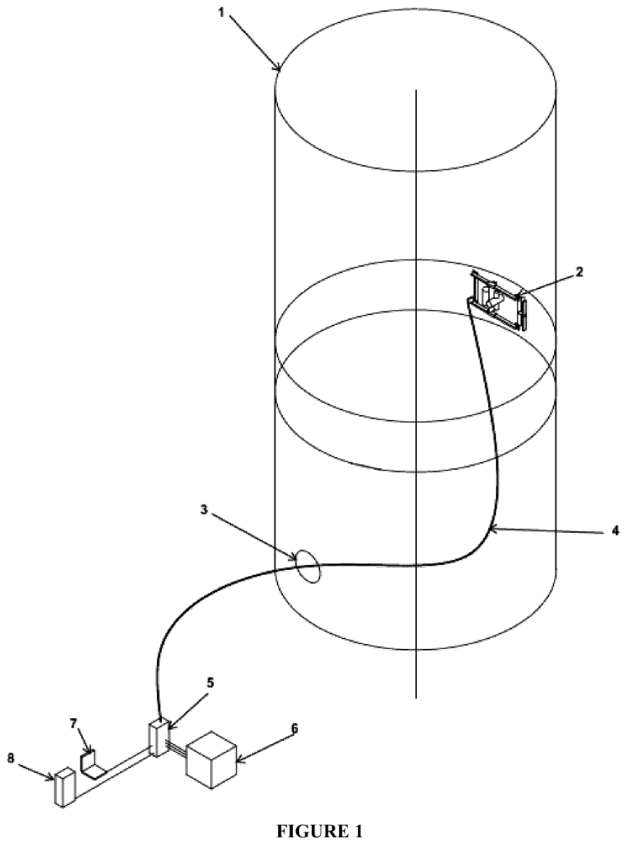

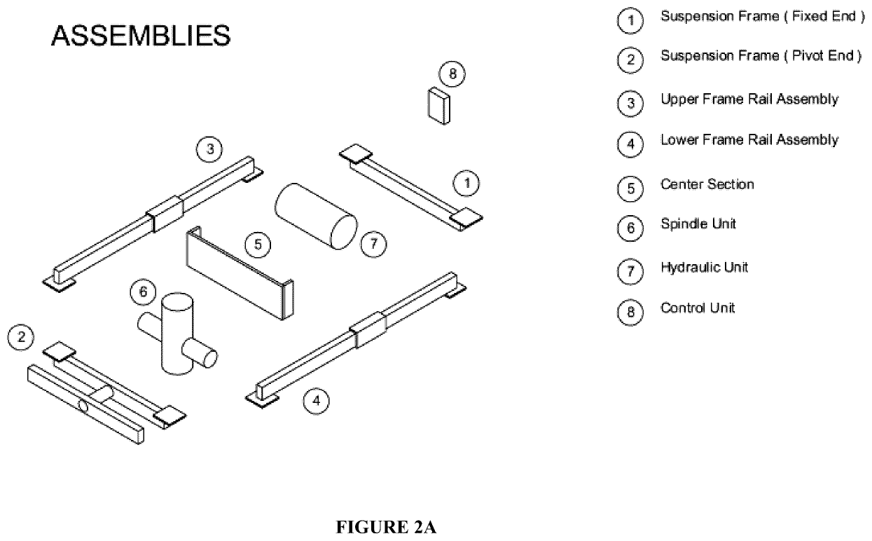

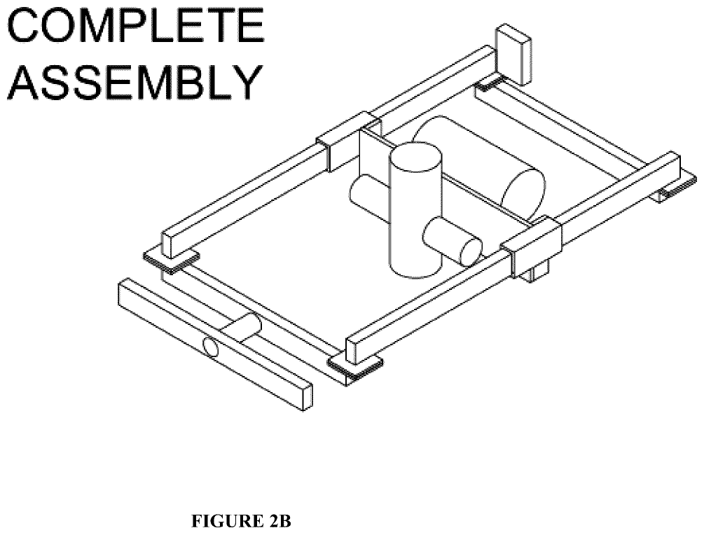

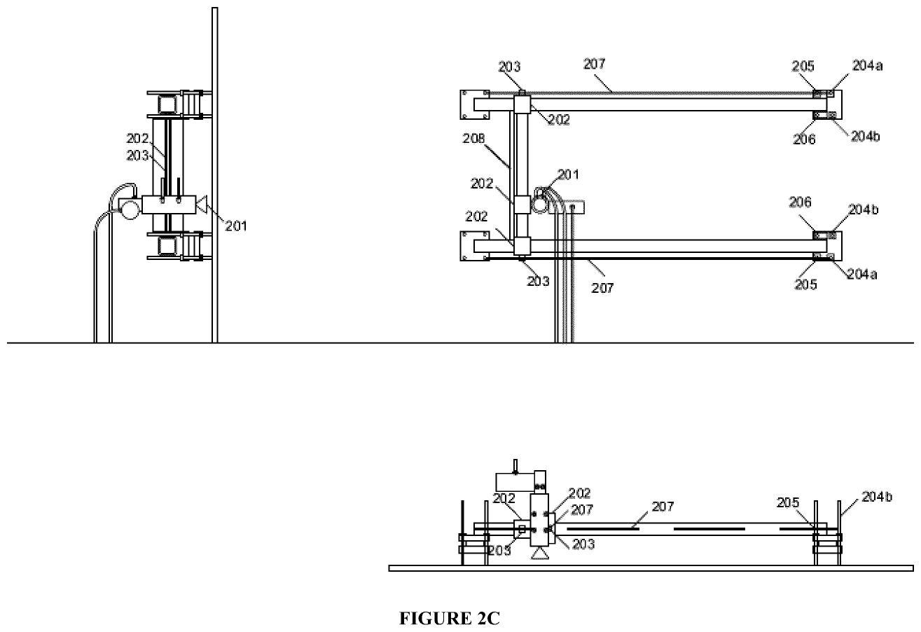

FIGS. 1 and 2A, 2B, and 2C show one embodiment of the system and device. However, one skilled in the art would recognize that the device and method may be applied in a number of applications, as explained in exemplary embodiments above.

Turning to FIG. 1, a VESSEL 1 is shown with the device 2 located on the inside periphery of the vessel 1. The device 2 incorporates an onboard CONTROL SYSTEM 7 and a CONSOLE 8 which may be connected to the device through an umbilical 4 and umbilical support unit 5 as known in the art or may be wirelessly connected to the CONTROL SYSTEM. In this embodiment, the umbilical 4 is fed through the manway located on the vessel 1. In one or more embodiments of the inventive device; if required, a chiller unit 6 is attached to the umbilical support unit 5 to supply coolant to the high-speed cutting head, motors and/or CONTROL SYSTEM of the inventive device during operation.

In one or more other embodiments, the device 2 may be wirelessly connected to the CONSOLE 8. The CONSOLE may be connected, either wirelessly or through the use of an umbilical, to the CONTROL SYSTEM which includes the INSTRUMENTATION SUITE, and which incorporates one or more components such as video cameras, microphones, thermal sensors, and vibration measurement sensors.

In one or more embodiments the device 2 can be mounted to the interior vessel wall or other surface and in a variety of ways, such as welding, magnetic connections, pressure mounting or other methods depending upon the requirements of the vessel being reconditioned. In one or more embodiments, the system further comprises a suspension system. In these embodiments, the suspension system is the interface between the vessel and the machine main frame. The suspension system allows the frame to be attached rigidly to the vessel at four points for maximum rigidity while eliminating any twisting moments to be applied to the main frame due to an uneven surface on the vessel. Several clamping methods can be used such as electromagnets, welding lugs, or push off from opposite surfaces.

After the device 2 is mounted to the interior vessel 1 wall, in one embodiment, the operator initiates the MAPPING process by activating a SCANNER located on the decladding device 2. The SCANNER may be an optical scanner, or any scanner as known in the art which is suitable to capture surface characteristics of the vessel. The data collected by the SCANNER is transmitted to the processor 7.

The processor 7 receives the SCANNER data and creates a digital representation of the VESSEL 1 surface. The processor 7 is programmed to provide instructions to the device 2 or to a second processor based on the mapped surface of the vessel 1. Specifically, in one or more embodiments, the processor provides the surface profile data model information to either a second processer or directly to the inventive device so that instructions provided based on the surface profile data model can be carried out by the various machining and/or welding tools. The instructions are with reference to the location and amount of metal to be removed or deposited from or to the VESSEL.

In one embodiment, the SCANNER analyzes the interior surface of the vessel 1, communicates the information to the processor 7 which analyzes the SCANNER data, maps the vessel surface, identifies or is programmed with the amount of material to be removed from the SUBSTRATE, by use of the cutting head (shown in FIG. 2C as 201) and then instructs the decladding device 2 to act. For example, the processor may instruct the decladding device 2 to remove approximately 0.010 inches of material from the vessel 1 wall at a specific location to remove old CLADDING and expose possible SUBSTRATE cracks.

In one or more embodiments, the user interface on the CONTROL SYSTEM is based on industry standard CNC (“computer numeric control”) technology. This control scheme allows for the user to control motion, spindle, and all other element of the device. Programs can be manually written, or preprogramed macros can be executed.

In one or more embodiments, after the initial decladding, the operator will re-initiate the MAPPING system to review the area which was just machined to ensure that the surface is ready for the application of replacement CLADDING.

In one or more embodiments, the data provided through the MAPPING SYSTEM 2 is reviewed and monitored by an operator and, if required, the operator may manually provide instructions to the device 2 by use of the CONSOLE 8.

The processor 7 also instructs the movement of the device 2. The device 2 is capable of movement along multiple axes simultaneously, which allows for mass metal removal (or deposits) at variable cutting depths and against flat or curved surfaces as appropriate. In one or more embodiments, the device 2 is capable of movement along five axes.

FIGS. 2A and 2B show one exemplary embodiment of the device used as a decladding device 2 as it might be incorporated into a COKER vessel. The inventive device comprises a suspension frame, rail assemblies, a center section, spindle (cutting head) unit, hydraulic unit, and a CONTROL SYSTEM unit as illustrated in the drawings.

In one embodiment, the device components are arranged and operate as follows. The main frame provides the linear guide box ways for the slide boxes and the lead screw assemblies and motors to position the X axis. The slide boxes provide a rigid and accurate bearing to slide along the main frame box ways. The center section attached to the slide boxes. The center section frame unit provides the linear bearing slides for the Y and Z axes along with the pivot (A axis) for the spindle. The spindle supports the cutting head with bearings, seals, coupling, hydraulic motor and attachment provisions to the pivot system. The spindle incorporates an industry tooling connection system so that a wide variety of “off the shelf” tooling can be used. The spindle drive is an electro-hydraulic power unit to provide controllable hydraulic power to the spindle motor. It consists of a 15-horsepower electric motor powered by a variable frequency electronic drive. In other embodiments, a variable displacement pump with computer-controlled displacement is used to control the hydraulic motor speed. The hydraulic pump attached to the electric motor provides hydraulic power to the spindle hydraulic motor. A distribution manifold, safety relief valve, filter unit, reservoir, and heat exchange are used in the spindle drive system to provide for required basic functions. A containment envelope around the hydraulic unit will mitigate any environmental concerns associated with a loss of hydraulic fluid. A minimum quantity of fluid (approx. 2-3 gallons) will allow for practical containment. Due to the small amount of oil and the compact footprint of the hydraulic unit a heat exchanger utilizing a water coolant loop is used to remove heat from the system. This hydraulic unit is located on the back side of the center section to keep the hose lengths as short as possible.

In one or more embodiments, the decladding device 2 is attached to the vessel 1 wall in any manner which allows the cutting head to be properly supported during the metal removal operations, regardless of the method of attachment. In all of these configurations, the center of the vessel can be and remain free from scaffolding and the operator of the decladding device can monitor and control the device from outside the vessel walls.

The inventive device is designed to minimize vibration and maximize rigidity so as to significantly reduce issues seen in prior attempts to perform automatic machining of VESSEL scams.

The device 2 and accompanying system is mobile and versatile based on its compact size and the ability of the device to incorporate industry standard cutting tools. The entire unit, including any associated support structures, can be efficiently moved to the different horizontal and vertical weld seams, as needed to accomplish the machining of the weld seams. The modular design of the invention also allows the device to be passed through manways present in most VESSELS and then be easily reassembled on the inside of the VESSEL.

The invention may also include a tool changing apparatus on the decladding (or welding) device which will allow the operator to select from a variety of tools in order to efficiently accomplish the machining of the VESSEL.

FIG. 2C shows another embodiment of the device as a decladding device 2. The device comprises a cutting head 201 secured to a frame comprising two arms. The two arms comprise a series of ball screws 207 and a coupling means 204, 205, 206. In one embodiment, the coupling means comprises a plurality of bellows, pulleys, and thrust bearings. However, any coupling means suitable to couple the decladding device to the vessel may be used.

Other embodiments such as circular frame geometries, or geometries using parallel kinematic structures can be used to support the decladding device.

In one or more embodiments, the device 2 is coupled to the vessel 1 wall in a straight beam configuration. In other embodiments, the device 2 is coupled to the vessel 1 wall in a curved beam configuration. In either configuration, the center of the vessel can be and remain free from scaffolding.

In addition to the two parallel arms, the device further comprises a perpendicular bar 208. The perpendicular bar 208 houses the cutting head 201 or other machining tool. The perpendicular bar 208 is connected to the two parallel arms in a manner that allows the perpendicular bar 208 to slide transversely. This connection means can be any means as known in the art, and in one embodiment comprises a plurality of ball nuts 203 and slide boxes 202.

In further embodiments, the device 2 is used as part of a wholistic repair system. For example, once the device 2 addresses cladding as discussed above, cracks may be observed using techniques known in the art. The user may position the device, with or without the cutting head, over the crack so that the SCANNER provides data to the processor to map the crack and to process the crack through modeling. In one or more embodiments, the device is driven to and manipulated on the crack by the user with a joystick or other remote control.

Various milling tools may be used to replace the cutting head in order to excavate or remove the crack based on the MAPPING and modeling information. The SCANNING, MAPPING, and milling are repeated in an iterative process until the entire crack has been successfully excavated or removed. This process can then be modeled by the processor in order to direct the device to perform other repair work such as smoothing the excavation and beveling the area to prepare the site for welding or further excavation and repair. With the modeling information gathered throughout the process, along with a surface area fully prepared, the identified area may then be welded or overlayed or otherwise repaired using a welding head attached to the device. Thus, in one or more embodiments, the system includes interchangeable components configured to re-apply weld overlay and/or to perform base metal repair.

In one or more embodiments, the tool may also be used to address curved surfaces outside of the vessel, including initial groove welds as part of the fabrication or installation of vessels/piping. For example, the tool may be used to excavate, bevel, weld and otherwise repair a skirt for a vessel. The same system may also be employed for other applications, such as for addressing repairs in piping or new installations via groove welding of the component parts.

For the purpose of understanding the Vessel Welding, Repair, and Reconditioning Method and System, references are made in the text to exemplary COKER embodiments of the method and system, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

What is claimed is:

1. A method for reconditioning a vessel comprising:
a) removably coupling a decladding device to the interior wall of a vessel, wherein said decladding device comprises a scanner, control system and a cutting head; and
b) actuating the scanner of the decladding device to provide surface characteristic information of the interior wall of said vessel to the control system which generates surface profile data model of the interior wall of the vessel and instructs the decladding device to remove metal from the substrate of the interior wall of said vessel based on the surface profile data model.

2. The method of claim 1 further comprising a decladding device support structure wherein said decladding device support structure comprises two parallel frame arms and one perpendicular frame arm, wherein said perpendicular frame arm supports said cutting head.

3. The method of claim 1 wherein said vessel comprises a coker vessel.

4. A system for decladding a vessel comprising:
a) a decladding device comprising a cutting head and a frame;
b) a control system in communication with said decladding device; and
c) an umbilical connected to the decladding device;
wherein said control system directs the amount of material removed by said decladding device based on the surface profile data map of the vessel as generated by a scanner and a mapping system.

5. The system of claim 5 wherein said control system directs said decladding device based on the surface profile characteristic data received from said scanner on the decladding device.

6. The system of claim 5 wherein the control system transmits information regarding the operation and control of the decladding device to a console which is monitored by a technician who can make adjustments to the device as needed during operation.

7. The system of claim 5 further comprising a crack excavation tool selected from the group consisting of: rotary files, endmills, and stones.

8. The system of claim 5 wherein said system performs machining of an existing weld overlay along with tapers as required to outside perimeters to eliminate stress risers.

9. The system of claim 9 wherein said machining results in a 10 to 1 profile.

10. The system of claim 9 wherein said machining results in a 3 to 1 profile.

11. The system of claim 5 wherein said decladding device comprises a three-point suspension system that is connected to said vessel at four points without imposing a torsional strain on said decladding device frame.

12. The system of claim 5 wherein said decladding device uses a modular design.

13. The system of claim 13 wherein said modular design is configured so that said decladding device may be reduced to several smaller modules that are capable of being transported through tight spaces such as access manways.

14. The system of claim 5 wherein said decladding device further comprises interchangeable components configured to re-apply weld overlay or to perform groove welding repairs to base metal, wherein said interchangeable components use coordinate geometry from the mapping systems.

15. A method for welding a vessel in situ comprising:
a) removably coupling a welding device comprising a welding head and an excavation tool to the wall of a vessel;
b) activating said welding device to autonomously:
i) apply a groove weld using said welding head on an identified area of said vessel;
ii) after applying said groove weld, identify repair work needed to said identified area; and
iii) perform said repair work on said identified area of said vessel, said repair work comprising excavating and removing at least one defect in said identified area of said vessel using said excavation tool.

16. The method of claim 15 wherein said excavation tool is selected from the group consisting of: rotary file, end mill, stone.

17. The method of claim 15 further comprising a control system that transmits information regarding the operation and control of said welding device to a console which is monitored by a technician who can make adjustments to the welding device as needed during operation.
